(19) United States
(12) Patent Application Publication
(10) Pub. No.: US 2016/0079595 A1
(43) Pub. Date: Mar. 17, 2016

(54) METHOD OF MANUFACTURING CATHODE ACTIVE MATERIAL FOR LITHIUM SECONDARY BATTERY AND LITHIUM SECONDARY BATTERY MANUFACTURED USING THE SAME

(71) Applicant: IUCF-HYU(INDUSTRY-UNIVERSITY COOPERATION FOUNDATION HANYANG UNIVERSITY), Seoul (KR)

(72) Inventors: Yang-Kook SUN, Seoul (KR); Sung June YOUN, Busan (KR); Hyung Joo NOH, Bucheon-si (KR); Eung Ju Lee, Seoul (KR)

(73) Assignee: IUCF-HYU(INDUSTRY-UNIVERSITY COOPERATION FOUNDATION HANYANG UNIVERSITY), Seoul (KR)

(21) Appl. No.: 14/954,329

(22) Filed: Nov. 30, 2015

Related U.S. Application Data
(63) Continuation of application No. PCT/KR2014/004903, filed on Jun. 2, 2014.

(30) Foreign Application Priority Data
May 31, 2013 (KR) 10-2013-0062984
Jun. 2, 2014 (KR) 10-2014-0067267

(51) Int. Cl. H01M 4/485; H01M 4/505; H01M 10/0525; H01M 4/525

(52) U.S. Cl. CPC H01M 4/485; H01M 4/525; H01M 4/505; H01M 10/0525; H01M 2220/20; H01M 2220/30

(57) ABSTRACT

The present disclosure relates to a method of manufacturing cathode active material for lithium secondary batteries and a lithium secondary battery manufactured using the same. Methods of manufacturing cathode active material for lithium secondary batteries according to embodiments of the inventive concept can fabricate cathode active material with improved stability and capacity by adjusting temperature of thermal treatment in accordance with concentration of transition metal which shows concentration gradient.

### CROSS-REFERENCE TO RELATED APPLICATIONS

This application is a continuation of International Application No. PCT/KR2014/004903 filed on Jun. 2, 2014, which claims priority from Korean Patent Application No. 10-2013-0062984 filed with Korean Intellectual Property Office on May 31, 2013 and Korean Patent Application No. 10-2014-0067267 filed with Korean Intellectual Property Office on Jun. 2, 2014, the entire contents of each of which are incorporated herein by reference.

### BACKGROUND

1. Field

The present disclosure relates to a method of manufacturing cathode active material for lithium secondary batteries and a lithium secondary battery manufactured using the same.

2. Description of Related Art

Recently, as utilization of portable electronic appliances such as camcorders, mobile phones, notebook PCs are generalized by rapid development of electronic, communication and computer industries, requirement for light batteries with long life and high reliability is elevated. Particularly, the requirement of the lithium secondary battery are increased day by day as power source for driving these portable electronic information communication devices because the lithium secondary batteries have driving voltage over 3.7 V and energy density per unit weight higher than nickel-cadmium batteries or nickel-hydrogen batteries.

Recently, studies about power sources for electric vehicles in hybrid an internal combustion engine and the lithium secondary battery are lively progressed in America, Japan, Europe and etc. A development for P-HEV (Plugin Hybrid Electric Vehicle) battery used for vehicles capable of less than 60 mile distance covered in a day are lively progressed around America. The P-HEV battery has characteristics little short of electric vehicle thereby the greatest problem is development of high capacity battery. Particularly, the greatest problem is development of a cathode material having high tab density over 2.0 g/cc and high capacity property over 230 mAh/g.

Cathode materials in common use or development are LiCoO₂, LiNiO₂, LiMnO₂, LiMn₂O₄, LiFePO₄ and etc. LiCoO₂ is a material having stable charge/discharge characteristics, superior electron conductivity, high battery voltage, high stability and flat discharge voltage property. However, cobalt (Co) is rare in deposits and expensive, in addition that, it has toxicity to human thereby requiring development for other cathode materials. Further, these have weakness of deteriorated thermal property because crystal structure is unstable by delithiation in charging.

To improve these problems, a lot of attempts in which transition metal element replaces for a part of nickel are trying in order to shift heat generation starting temperature to high temperature portion or make heat peak broaden for preventing rapid heat generation. However, satisfaction has not been acquired yet.

In other words, LiNi₁₋ₓCoₓO₂(x=0.1-0.3) material in which cobalt substitutes for a portion of nickel shows superior charge/discharge property and cycle life characteristics, however, thermal stability problem is not solved. In addition, Europe Patent No. 0872450 discloses LiₐCo_{b}Mn_{c}M_{d}Ni_{1-(b+c+d)}O₂(M=B, Al, Si, Fe, Cr, Cu, Zn, W, Ti and Ga) type in which another metal as well as cobalt and manganese substitute for nickel locations, however, thermal stability problem is also not solved

To remove these weak points, Korea Patent Publication No. 10-2005-0083869 suggests lithium transition metal oxide showing concentration gradient of metal composition. In this method, interior material of predetermined composition is synthesized and coated by a material with different composition to be double layer followed by mixing with lithium salt and performing thermal treatment. Lithium transition metal oxide which is commercially available may be used as the interior material. However, this method has a problem of unstable interior structure because metal composition of cathode active material between the inner material and outer material is not changed gradually but discontinuously changed. Further, powder synthesized by this invention has insufficient tap density because ammonia as chelating agent is not used, thereby the powder is not suitable for cathode active material of lithium secondary batteries.

To make up for these points, Korea Patent Publication No. 2007-0097923 has suggested cathode active material in which an inner bulk portion and an outer bulk portion are disposed, and the outer bulk portion shows continuous concentration distribution of metal compositions according to location. Since metal composition is changed in the outer bulk portion but constant in the inner bulk portion, there is a necessity of developing cathode active material which has new structure with superior stability and capacity.

### SUMMARY

To solve the above problems of the conventional art, embodiments of the inventive concept provide new method of manufacturing cathode active material for lithium secondary battery showing concentration gradient.

Embodiments of the inventive concept may provide a method of manufacturing cathode active material for lithium secondary battery comprising: preparing transition metal oxide; mixing the transition metal oxide and lithium composition; and conducting thermal treatment.

In some embodiments, the conducting of the thermal treatment may include changing a temperature of the thermal treatment at least one time. For example, the conducting of the thermal treatment may include conducting a thermal treatment at a first temperature for a first time, and conducting a thermal treatment at a second temperature differ from the first temperature for a second time. Changing from the first temperature to the second temperature may be conducted continuously in a reactor where the thermal treatment is conducted.

In other embodiments, the conducting of the thermal treatment may include changing the temperature of the thermal treatment in stair shape. The changing of the temperature may be at least one time. Alternatively, the conducting of the thermal treatment may include continuously changing the temperature of the thermal treatment. In other words, the temperature changing of the thermal treatment may be represented by a linear function or a higher order function. For example, the temperature changing of the thermal treatment may be increased or decreased in a linear shape as the linear function, or increased or decreased in a curved shape as the higher order function.

In yet other embodiments, the conducting of the thermal treatment may include that the temperature of the thermal treatment is increased. In other words, the temperature of the thermal treatment may be increasing as increasing a reaction time. The rate of temperature may be constant, a linear function or a higher order function.

In still other embodiments, the conducting of the thermal treatment may include conducting a first thermal treatment at 400° C. through 500° C.; conducting a second thermal treatment at 700° C. through 800° C.; and conducting a third thermal treatment at 800° C. through 900° C.

In yet still other embodiments, temperature of the first, second and third thermal treatments may be changed in accordance with interior constitution. As Ni content is increased, the temperature of the first thermal treatment may become lower. When Ni content is in the same, the temperature of the thermal treatment may be changed in accordance with Mn content.

In further embodiments, the conducting of the second thermal treatment may include 2-n step in which the thermal treatments are conducted at temperature of T₂₋ₙ, wherein n is at least 2.

In yet further embodiments, the temperature of the thermal treatment T₂₋ₙ in 2-n step and the temperature of the thermal treatment T₂₋₍ₙ₋₁₎ in 2-(n-1) step may satisfy following relative equation 1.

T₂₋₍ₙ₋₁₎≦T₂₋ₙ. [Relative Equation 1]

In other words, the method of manufacturing cathode active material of lithium secondary batteries may include a thermal treatment step which is separated by n intervals in the second thermal treatment and each step is the same as or higher than prior step in temperature of the thermal treatment.

In still further embodiment, the conducting of the third thermal treatment may include 3-n step in which the thermal treatments are conducted at temperature of T₃₋ₙ, wherein n is at least 2.

In even further embodiment, the temperature of the thermal treatment T₃₋ₙ in 3-n step and the temperature of the thermal treatment T₃₋₍ₙ₋₁₎ in 3-(n-1) step may satisfy following relative equation 2.

T₃₋₍ₙ₋₁₎≦T₃₋ₙ. [Relative Equation 2]

In other words, the method of manufacturing cathode active material of lithium secondary batteries may include a thermal treatment step which is separated by n intervals in the third thermal treatment and each step is the same as or higher than prior step in temperature of the thermal treatment.

In still even further embodiment, in the conducting of the third thermal treatment, the concentration may be gradually increasing as elevating to the final temperature from the temperature of the second thermal treatment. The time for elevating temperature may be adjustable.

Embodiments of the inventive concept may provide a cathode active material which is manufactured using the method described above.

In some embodiments, the cathode active material may be represented in following chemical formula 1.

LiₐM1ₓM2_{y}M3_{z}M4_{w}O_{2+δ}, [Chemical Formula 1]

wherein M1, M2 and M3 are selected from a group including Ni, Co, Mn and compound thereof, M4 is selected from a group including Fe, Na, Mg, Ca, Ti, V, Cr, Cu, Zn, Ge, Sr, Ag, Ba, Zr, Nb, Mo, Al, Ga, B and compound thereof, 0.9<a≦1.1, 0≦x≦1, 0≦y≦1, 0≦z≦1, 0≦w≦0.1, 0.0≦δ≦0.02, and 0<x+y+z≦1, and wherein at least one of M1, M2 and M3 shows concentration gradient at a portion of a particle.

In other embodiments, the cathode active material may include a first region represented in following chemical formula 2, having constant concentration of M1, M2 and M3, and having the radius of R2 from a center.

Liₐ₁M1ₓ₁M2_{y1}M3_{z1}O_{2+δ}; [Chemical Formula 2]

and a second region formed around of the first region, having concentration gradient of M1, M2 and M3 from constitution of the chemical formula 2 to the following chemical formula 3, and having the thickness of D2,

Liₐ₂M1ₓ₂M2_{y2}M3_{z2}M4_{w}O_{2+δ}, [Chemical Formula 3]

wherein, in the chemical formulas 2 and 3, M1, M2 and M3 are selected from a group including Ni, Co, Mn and composition thereof, M4 is selected from Fe, Na, Mg, Ca, Ti, V, Cr, Cu, Zn, Ge, Sr, Ag, Ba, Zr, Nb, Mo, Al, Ga, B and composition thereof, 0<a1≦1.1, 0<a2≦1.1, 0≦x1≦1, 0≦x2≦1, 0≦y1≦1, 0≦y2≦1, 0≦z1≦1, 0≦z2≦1, 0≦w≦0.1, 0.0≦δ≦0.02, 0<x1+y1+z1≦1, 0<x2+y2+z2≦1, x1≦x2, y1≦y2, z2≦z1, 0≦R1≦0.5 μm and 0≦D1≦1.0 μm.

In still other embodiments, the cathode active material further may include a third region formed around the second region, having constant concentration of M1, M2 and M3 and having the thickness of D2 D2(0≦D2≦0.5 μm).

In yet other embodiments, the concentration gradients of M1, M2 and M3 may be constant in entire particle.

In still yet embodiments, an inflection point where concentration gradients of M1, M2 and M3 are changed may be located in a particle.

In further embodiments, M1, M2 and M3 may have two concentration gradients in a particle.

### BRIEF DESCRIPTION OF THE DRAWINGS

The inventive concept will become more apparent in view of the attached drawings and accompanying detailed descriptions.

FIGS. 1 to 11 shows results of measuring charge/discharge characteristics for batteries which include cathode active material manufactured in example embodiment and comparative embodiments.

### DETAILED DESCRIPTION OF THE EMBODIMENTS

The inventive concept will now be described more fully hereinafter with reference to the accompanying drawings, in which embodiments of the inventive concept are shown. It should be noted, however, that the inventive concept is not limited to the following embodiments, and may be implemented in various forms.

### Example Embodiment 1

In order to make an active material having a concentration maintaining portion at the outermost shell, in which nickel concentration is continuously decreasing as going to the surface from the center, and cobalt and manganese concentration is increasing as going to the surface from the center, first of all, 2.4M metal salt solution for forming a core part in which nickel sulfate:cobalt sulfate:manganese sulfate are mixed at the molar ratio of 95:2:3, a metal salt solution for forming a shell part in which nickel sulfate:cobalt sulfate:manganese sulfate are mixed at the molar ratio of 75:8:17 and a metal salt solution for forming a maintaining part in which nickel sulfate:cobalt sulfate:manganese sulfate are mixed at the molar ratio of 64:10:26 were prepared.

Distilled water 4 liters was poured into a coprecipitation reactor (capacity 4 L, rotation motor power 80 W) and nitrogen gas was supplied into the reactor at the rate of 0.5 liter/min to remove dissolved oxygen followed by stirring at 1000 rpm while keeping the reactor temperature at 50° C.

The metal salt solution for forming the core part and the metal salt solution for forming the shell part was continuously put into the reactor at the rate of 0.3 liter/hour, and 3.6 M ammonia solution was continuously put into the reactor at the rate of 0.03 liter/hour.

Further, for adjusting pH, 4.8 M sodium hydroxide (NaOH) solution was supplied thereto to keep pH at 11. Impeller speed of the reactor was controlled to 1000 rpm such that coprecipitation reaction was performed until the diameter of getting sediment is 1 μm. Finally, the solution for forming concentration maintaining part was put in to form the maintaining part at the outermost shell.

Average retention time of the solution in the reactor became about 2 hours by controlling flow rate. After reaching the reaction at normal status, normal status duration was given to reactant such that coprecipitation composite with higher density was manufactured. The composite was filtered and washed followed by drying in 110° C. hot air dryer for 15 hours, thereby an active material precursor was manufactured.

LiNO₃ as lithium salt was mixed to the manufactured active material precursor, heated at the rate of 2° C./min and kept at 450° C. for 10 hours for conducting first thermal treatment, and thermal treatment 2-1 and thermal treatment 2-2 were conducted by calcining at 730° C. and 780° C. for 5 hours, respectively. Then, third thermal treatment was conducted by calcining at 810° C. for 5 hours to obtain final active material particles. The diameter of the active material particle was 12 μm

### Comparative Embodiment 1

Active material particles were manufactured as the example embodiment 1 except for conducting the first thermal treatment kept at 450° C. for 10 hours followed by conducting thermal treatment at 810° C. for 15 hours.

<Test Embodiment> Measuring Charge/Discharge Characteristics

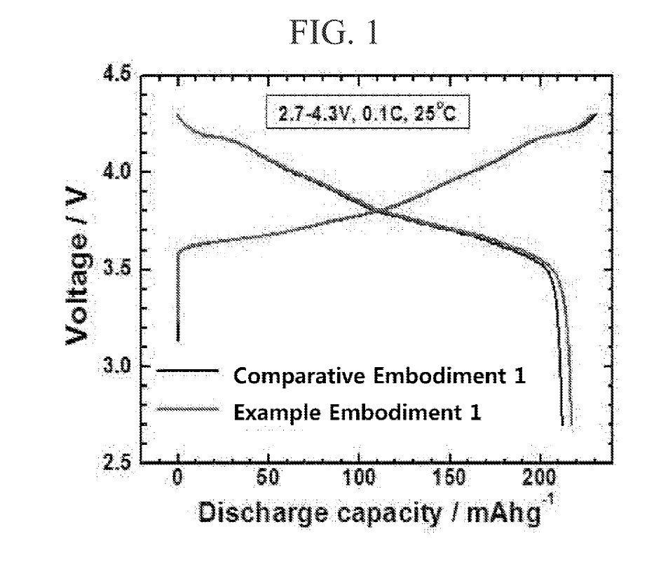

After manufacturing a cathode using the active material particles which were manufactured by the example embodiment 1 and the comparative embodiment, charge/discharge characteristics were measured and shown in FIG. 1 and following table 1.

TABLE 1

| | Capacity | 1^{st} Charge/ | Life Time Property |
|---|---|---|---|
| | (mAh/g) | Discharge | (%) −2.7-4.3 V, |
| | 2.7-4.3 V, 0.1 C | Efficiency (%) | 0.5 C, 100 cycle |
| Example | 217.3 | 94.8 | 92.3 |
| Embodiment 1 | | | |
| Comparative | 212.1 | 91.8 | 88.7 |
| Embodiment 1 | | | |

### Example Embodiment 2

In order to make particles having two concentration gradient with a inflection point where concentration gradient is changed in a particle, 2.4M metal salt solution for forming a core part in which nickel sulfate:cobalt sulfate:manganese sulfate are mixed at the molar ratio of 95:2:3, a metal salt solution for forming a shell part in which nickel sulfate:cobalt sulfate:manganese sulfate are mixed at the molar ratio of 67:9:24 and a metal salt solution for forming the inflection point in which nickel sulfate:cobalt sulfate:manganese sulfate are mixed at the molar ratio of 90:4:6 were prepared, and a metal salt solution for forming a concentration maintaining part in which nickel sulfate:cobalt sulfate:manganese sulfate are mixed at the molar ratio of 60:15:25 were prepared,

Active material were manufactured as the example embodiment 1 except for conducting thermal treatment 2-2 at 780° C. for 5 hours and gradually elevating temperature to 810° C. of the third thermal treatment and conducting the third thermal treatment at 810° C. for 5 hours

### Comparative Embodiment 2

Active material particles were manufactured as the example embodiment 2 except for conducting the first thermal treatment kept at 450° C. for 10 hours followed by conducting thermal treatment at 810° C. for 15 hours.

<Test Embodiment> Measuring Charge/Discharge Characteristics

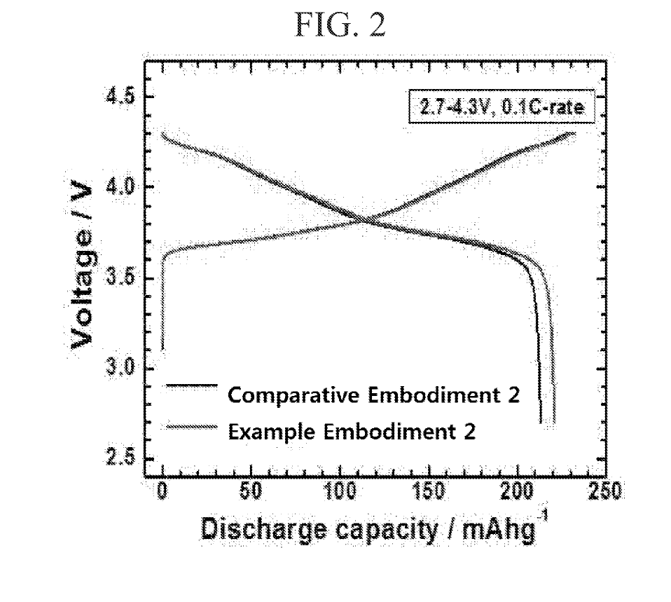

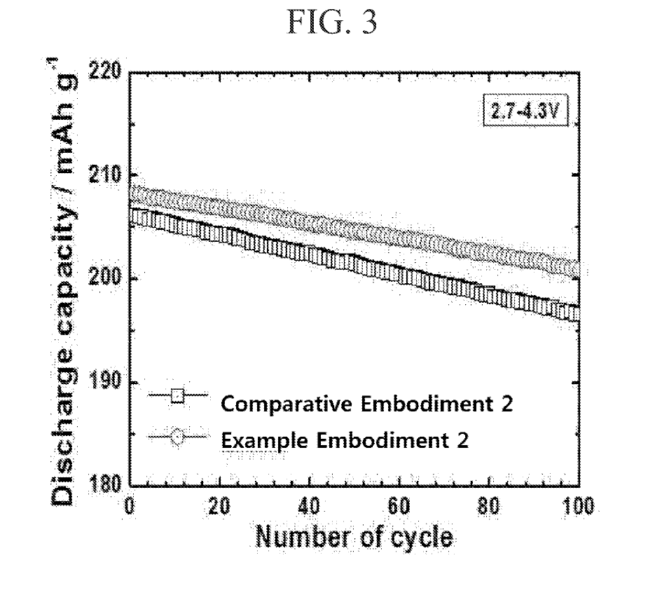

After manufacturing a cathode using the active material particles which were manufactured by the example embodiment 2 and the comparative embodiment 2, charge/discharge characteristics were measured and shown in FIGS. 2, 3 and following table 2.

TABLE 2

| | 1^{st} Charge/Discharge Efficiency (%) |
|---|---|
| Comparative Embodiment 2 | 92.9 |
| Example Embodiment 2 | 95.2 |

### Example Embodiment 3

In order to make particles having two concentration gradient with an inflection point where concentration gradient is changed in a particle, as the example Embodiment 1, the first thermal treatment at 450° C. for 10 hours except for preparing 2.4M metal salt solution for forming a core part in which nickel sulfate:cobalt sulfate:manganese sulfate are mixed at the molar ratio of 95:2:3, a metal salt solution for forming a shell part in which nickel sulfate:cobalt sulfate:manganese sulfate are mixed at the molar ratio of 67:9:24 and a metal salt solution for forming the inflection point in which nickel sulfate:cobalt sulfate:manganese sulfate are mixed at the molar ratio of 90:4:6, and a metal salt solution for forming a concentration maintaining part in which nickel sulfate:cobalt sulfate:manganese sulfate are mixed at the molar ratio of 60:15:25.

Then, the thermal treatment 2-1 and the thermal treatment 2-2 were conducted by calcining at 730° C. and 780° C. for 5 hours, respectively. And, the third thermal treatment was conducted by calcining at 810° C. for 5 hours to obtain final active material particles.

### Comparative Embodiment 3

Active material particles were manufactured as the example embodiment 1 except for conducting the first thermal treatment kept at 450° C. for 10 hours followed by conducting thermal treatment at 810° C. for 15 hours.

<Test Embodiment> Measuring Charge/Discharge Characteristics

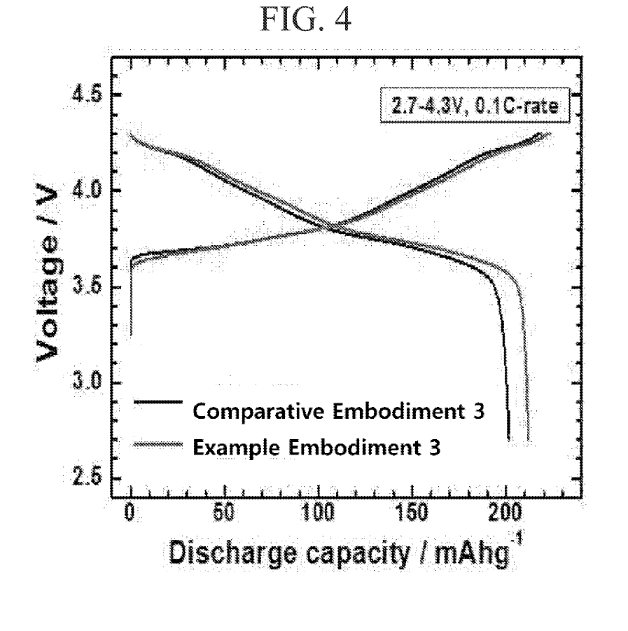

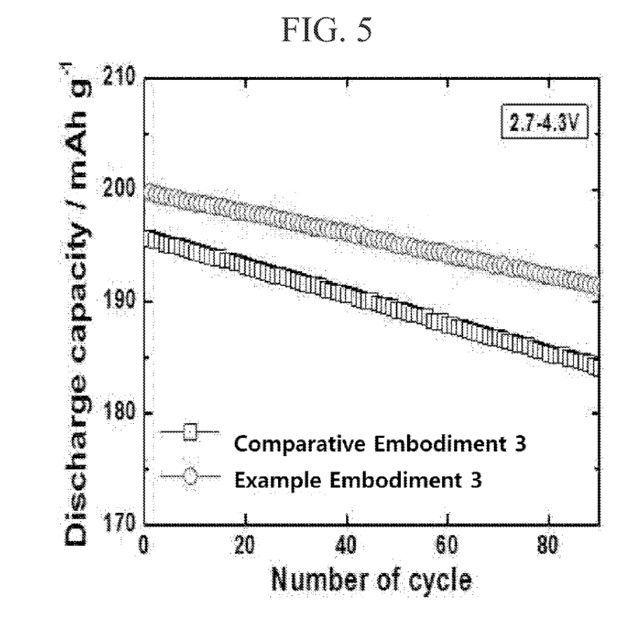

After manufacturing a cathode using the active material particles which were manufactured by the example embodiment 3 and the comparative embodiment 3, charge/discharge characteristics were measured and shown in FIGS. 4, 5 and following table 3.

TABLE 3

| | 1^{st} Charge/Discharge Efficiency (%) |
|---|---|
| Comparative Embodiment 3 | 92.3 |
| Example Embodiment 3 | 94.7 |

### Example Embodiment 4

As the example Embodiment 1, the first thermal treatment at 450° C. for 10 hours were conducted except for preparing 2.4M metal salt solution for forming a core part in which nickel sulfate:cobalt sulfate:manganese sulfate are mixed at the molar ratio of 96:2:2, a metal salt solution for forming a shell part in which nickel sulfate:cobalt sulfate:manganese sulfate are mixed at the molar ratio of 70:10:20 and a metal salt solution for forming an inflection point in which nickel sulfate:cobalt sulfate:manganese sulfate are mixed at the molar ratio of 91:4:5.

Then, the thermal treatment 2-1 and the thermal treatment 2-2 were conducted by calcining at 730° C. and 780° C. for 5 hours, respectively. A third thermal treatment was conducted by calcining at 810° C. for 5 hours to obtain final active material particles.

### Example Embodiment 5

Cathode active material were manufactured as the example embodiment 4 except for conducting the thermal treatment 2-2 at 780° C. for 5, and elevating temperature to 810° C. of the third thermal treatment followed by conducting third thermal treatment at 810° C. for 15 hours.

### Comparative Embodiment 4

Active material particles were manufactured by the example embodiment 4 except for conducting the first thermal treatment kept at 450° C. for 10 hours followed by conducting thermal treatment at 810° C. for 15 hours.

<Test Embodiment> Measuring Charge/Discharge Characteristics

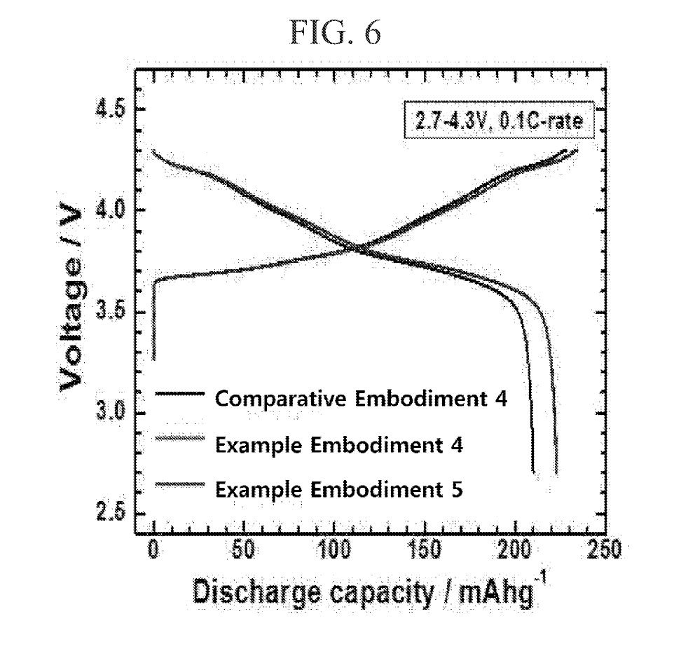

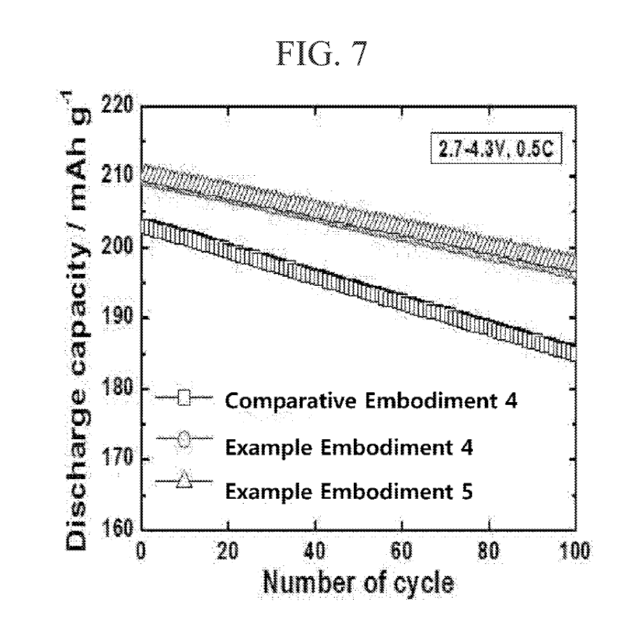

After manufacturing a cathode using the active material particles which were manufactured by the example embodiments 4 and 5, and the comparative embodiment 4, charge/discharge characteristics were measured and shown in FIGS. 6 and 7, and following table 4.

TABLE 4

| | 1^{st} Charge/Discharge Efficiency (%) |
|---|---|
| Comparative Embodiment 4 | 90.8 |
| Example Embodiment 4 | 94.9 |
| Example Embodiment 5 | 95.0 |

### Example Embodiment 6

In order to make particles without a concentration maintaining portion at the outermost shell, active material particles were manufactured by conducting thermal treatment as the example embodiment 1 except for using 2.4M metal salt solution for forming a core part in which nickel sulfate:cobalt sulfate:manganese sulfate are mixed at the molar ratio of 98:1:1, a metal salt solution for forming a shell part in which nickel sulfate:cobalt sulfate:manganese sulfate are mixed at the molar ratio of 70:9:21, and a metal salt solution for forming an inflection point where concentration gradient is changed, in which nickel sulfate:cobalt sulfate:manganese sulfate are mixed at the molar ratio of 90:4:6.

### Comparative Embodiments 5 and 6

Active material particles of comparative embodiments 5 and 6 were manufactured as the example embodiment 4 except for conducting the first thermal treatment kept at 450° C. for 10 hours followed by conducting thermal treatment at 810° C. for 15 hours.

<Test Embodiment> Measuring Charge/Discharge Characteristics

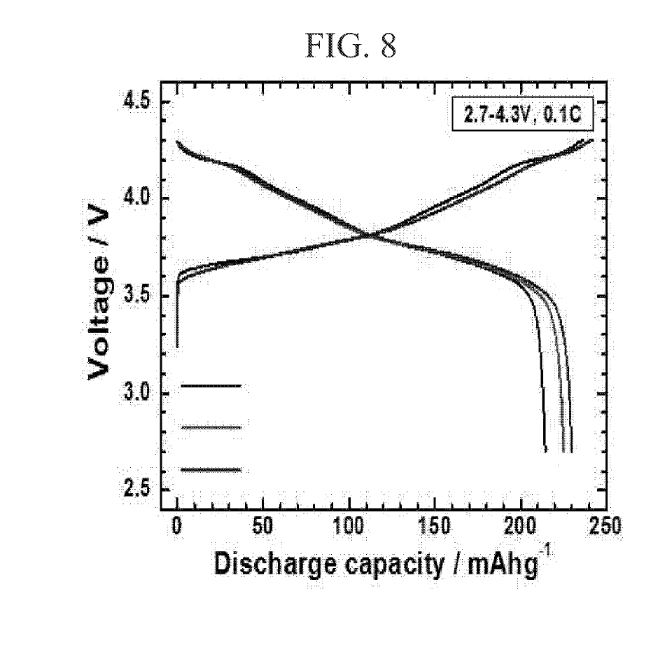

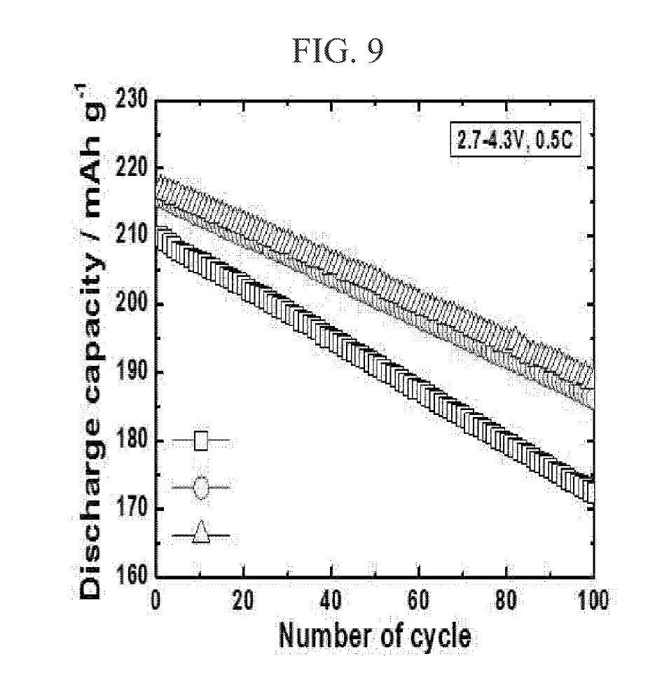

After manufacturing a cathode using the active material particles which were manufactured by the example embodiment 6 and the comparative embodiments 5 and 6, charge/discharge characteristics were measured and shown in FIGS. 8 and 9, and following table 5.

TABLE 5

| | 1^{st} Charge/Discharge Efficiency (%) |
|---|---|
| Comparative Embodiment 5 | 90.7 |
| Comparative Embodiment 6 | 93.1 |
| Example Embodiment 6 | 94.9 |

### Example Embodiment 7

Active material particles were manufactured as the example embodiment 1 except for using 2.4M metal salt solution for forming a core part in which nickel sulfate:cobalt sulfate:manganese sulfate are mixed at the molar ratio of 98:0:2, a metal salt solution for forming a shell part in which nickel sulfate:cobalt sulfate:manganese sulfate are mixed at the molar ratio of 79:8:23, and a concentration maintaining part at outermost shell in which nickel sulfate:cobalt sulfate:manganese sulfate are mixed at the molar ratio of 60:12:28, and forming the thickness of the core part at 1.0 μm.

### Comparative Embodiment 7

Active material particles were manufactured as the example embodiment 7 except for conducting the first thermal treatment kept at 450° C. for 10 hours followed by conducting thermal treatment at 810° C. for 15 hours.

<Test Embodiment> Measuring Charge/Discharge Characteristics

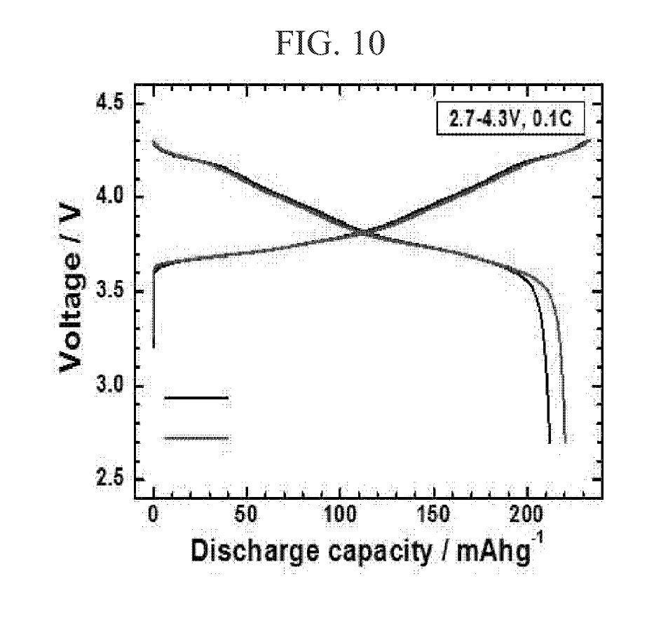

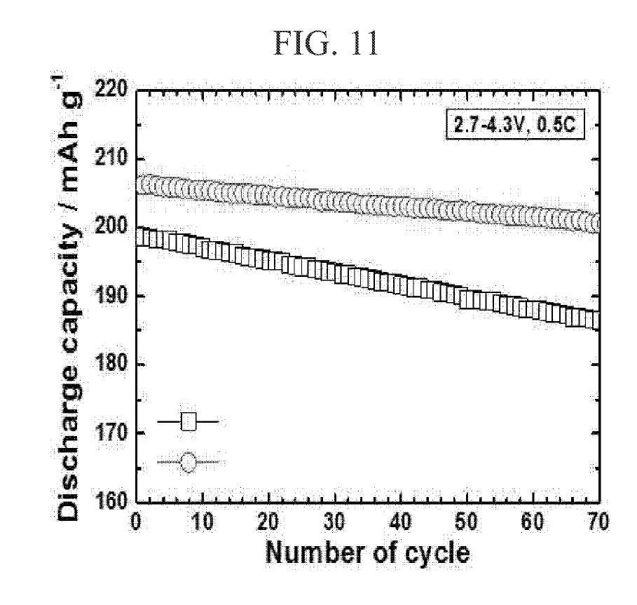

After manufacturing a cathode using the active material particles which were manufactured by the example embodiment 7 and the comparative embodiment 7, charge/discharge characteristics were measured and shown in FIGS. 10 and 11, and following table 6.

TABLE 6

| | 1^{st} Charge/Discharge Efficiency (%) |
|---|---|
| Comparative Embodiment 7 | 90.9 |
| Example Embodiment 7 | 94.1 |

According to embodiments of the inventive concept, temperature of thermal treatment is controlled in accordance with concentration of transition metal showing concentration gradient, thereby cathode active material can be manufactured with improved stability and capacity.

Methods of manufacturing cathode active material for lithium secondary batteries according to embodiments of the inventive concept can fabricate cathode active material with improved stability and capacity by adjusting temperature of thermal treatment in accordance with concentration of transition metal which shows concentration gradient.

What is claimed is:

1. A method of manufacturing cathode active material for lithium secondary battery, the method comprising:
preparing transition metal oxide;
mixing the transition metal oxide and lithium composition; and
conducting thermal treatment.

2. The method of claim 1, wherein, in the conducting of the thermal treatment, temperature of the thermal treatment is changed at least one time.

3. The method of claim 2, wherein, in the conducting of the thermal treatment, the temperature of the thermal treatment is changed in stair shape.

4. The method of claim 2, wherein, in the conducting of the thermal treatment, the temperature of the thermal treatment is continuously changed.

5. The method of claim 2, wherein, in the conducting of the thermal treatment, the temperature of the thermal treatment is increased.

6. The method of claim 1, wherein the conducting of the thermal treatment comprises:
conducting a first thermal treatment at 400° C. through 500° C.;
conducting a second thermal treatment at 700° C. through 800° C.; and
conducting a third thermal treatment at 800° C. through 900° C.

7. The method of claim 6, wherein the conducting of the second thermal treatment comprises: 2-1 step through 2-n step in which the thermal treatments are conducted respectively at temperature of T₂₋ₙ, wherein n is at least 2.

8. The method of claim 7, wherein the temperature of the thermal treatment T₂₋ₙ, in 2-n step and the temperature of the thermal treatment T₂₋₍ₙ₋₁₎ in 2-(n-1) step satisfy following relative equation 1,
T₂₋₍ₙ₋1)≦T₂₋ₙ [Relative Equation 1].

9. The method of claim 6, wherein the conducting of the third thermal treatment comprises 3-1 step through 3-n step in which the thermal treatments are conducted respectively at temperature of T₃₋ₙ, wherein n is at least 2.

10. The method of claim 6, wherein the temperature of the thermal treatment T₃₋ₙ, in 3-n step and the temperature of the thermal treatment T₃₋₍ₙ₋₁₎ in 3-(n-1) step satisfy following relative equation 2,
T₃₋₍ₙ₋₁₎≦T₃₋ₙ [Relative Equation 2].

11. The method of claim 6, wherein in the conducting of the third thermal treatment, concentration is gradually increasing as elevating to the temperature of the third thermal treatment from the temperature of the second thermal treatment.

12. A cathode active material for a lithium secondary battery, which is manufactured using the method of claim 1.

13. The cathode active material of claim 12, wherein the cathode active material is represented in following chemical formula 1,
LiₐM1ₓM2_{y}M3_{z}M4_{w}O_{2+δ,} [Chemical Formula 1]
wherein M1, M2 and M3 are selected from a group including Ni, Co, Mn and compound thereof, M4 is selected from a group including Fe, Na, Mg, Ca, Ti, V, Cr, Cu, Zn, Ge, Sr, Ag, Ba, Zr, Nb, Mo, Al, Ga, B and compound thereof, 0.9<a≦1.1, 0≦x≦1, 0≦y≦1, 0≦z<1, 0≦w≦0.1, 0.0≦δ≦0.02, and 0<x+y+z≦1, and
wherein at least one of M1, M2 and M3 shows concentration gradient at a portion of a particle.

14. The cathode active material of claim 12, wherein the cathode active material comprises:
a first region represented in following chemical formula 2 and having constant concentration of M1, M2 and M3, and having the radius of R2 from a center,
Liₐ₁M1ₓ₁M2_{y1}M3_{z1}O_{2+δ} [Chemical Formula 2]; and
a second region formed around of the first region and having concentration gradient of M1, M2 and M3 from constitution of the chemical formula 2 to the following chemical formula 3, and having the thickness of D2,
Liₐ₂M1ₓ₂M2_{y2}M3_{z2}M4_{w}O_{2+δ} [Chemical Formula 3]
wherein, in the chemical formulas 2 and 3, M1, M2 and M3 are selected from a group including Ni, Co, Mn and composition thereof, M4 is selected from Fe, Na, Mg, Ca, Ti, V, Cr, Cu, Zn, Ge, Sr, Ag, Ba, Zr, Nb, Mo, Al, Ga, B and composition thereof, 0<a1≦1.1, 0<a2≦1.1, 0≦x1≦1, 0≦x2≦1, 0≦y1≦1, 0≦y2≦1, 0≦z1≦1, 0≦z2≦1, 0≦w≦0.1, 0.0≦δ≦0.02, 0<x1+y1+z1≦1, 0<x2+y2+z2≦1 , x1≦x2, y1≦y2, z2≦z1, 0≦R1≦0.5 μm and 0≦D1≦1.0 μm.

15. The cathode active material of claim 12, wherein the cathode active material further comprises a third region formed around the second region and having constant concentration of M1, M2 and M3 and having the thickness of D2 D2(0≦D2≦0.5 μm).

16. The cathode active material of claim 12, wherein the concentration gradients of M1, M2 and M3 are constant in entire particle.

17. The cathode active material of claim 12, wherein an inflection point where concentration gradients of M1, M2 and M3 are changed is located in a particle.

18. The cathode active material of claim 12, wherein M1, M2 and M3 have two concentration gradients in a particle.
